(19) United States
(12) Patent Application Publication
(10) Pub. No.: US 2002/0129222 A1
(43) Pub. Date: Sep. 12, 2002

(54) System for presenting communications capacity

(76) Inventors: Petri Aukia, Mantsala (FI); Mika Karjalainen, Helsinki (FI)

Correspondence Address: YOUNG & THOMPSON, 745 SOUTH 23RD STREET 2ND FLOOR, ARLINGTON, VA, 22202

(21) Appl. No.: 10/102,685

(22) Filed: Mar. 22, 2002

Related U.S. Application Data
(60) Provisional application No. 60/220,206, filed on Jul. 24, 2000.

(51) Int. Cl. G06F 7/00

(52) U.S. Cl. 712/1

(57) ABSTRACT

The system of generating presentation of network capacity and price collects from various sources information about communication capabilities and prices, processes this information and stores the processed information on a storage medium. In response to a local or remote user's request, a piece of the processed information is retrieved from the storage medium and transmitted as a presentation to the user's computer for displaying on the user's display device. Preferably, processed information is displayed on a map, in charts, and/or in tables. Additional data not shown immediately on the screen is also sent. This data or some items of it is displayed only in response to the user's selection. The map with the processed information and the additional information enables the user to do various analyses relating to network capacity being offered and based on the analyses the user can select an offer.

This application is a continuation of co-pending application No. PCT/FI01/00682, filed on Jul. 24, 2001, which claimed benefit of U.S. provisional application No. 60/220,206, filed Jul. 24, 2000, and which designated the United States.

### FIELD OF THE INVENTION

The present invention relates generally to buying and selling telecommunication capacity. More particularly, the invention relates to a computer-implemented system offering a centralized platform for buyers to see and select telecommunication network capacity being offered on the distributed network capacity market.

### BACKGROUND OF THE INVENTION

World-wide wholesale trade of oil and gas has long been concentrated in special exchanges. Similar tendency is now going in the field of electrical energy because energy markets around the world are rapidly being deregulated. International wholesale of telecom capacity is also emerging.

Various tools for trading oil, gas, and even electric energy have been developed but there are very few tools for trading telecom bandwidth.

A British company, Lacima Consultants Ltd., has developed pricing software that provides prices on conventional financial assets, commodities, and perishable commodities, such as electricity. The pricing software does not contain maps, alternative product selection and inclusion in price profile calculation, search and display of results on a map.

A British company, Band-X Ltd. has launched the first independent platform for trading bandwidth in 1997. It offers a virtual market for international wholesale telecom capacity. The Internet based exchange provides a portal for buyers and sellers of bandwidth. It acts a clearing market and performs billing, settlement, arbitration and quality monitoring. The company provides prices for the links sold on their exchange in tabular form using a telecommunications network. These prices are updated in real-time or near real-time. In addition to display of tables, rudimentary searches based on the location of end-points or the exact bandwidth desired can be executed.

U.S. Pat. No. 6,055,504, inventors Garg Amit and Chou Yu-Li, describes a system that identifies a plurality of players in the communication network capacity market are identified and then provides a neutral third-party. The neutral third party and the plurality of players are configured in a hub arrangement for communicating with each of the plurality of players in communication network capacity trades. Under the hub the communication network capacity supplied by one or more of the players can be bought and sold among the players and the neutral third party can preserve anonymity of each of the plurality of players soliciting communication network capacity.

A drawback of the prior art systems of methods is that they do not solve the problem how to determine effectively the existence of tradable telecommunications capabilities or their OTC (Over-the-Counter) alternatives, their price, the price correlation of the capabilities and their geographical or topological mapping. The telecommunications capabilities include any capability of transferring information. Price determination of capabilities of information transfer is difficult, since many different telecommunications products and services can alone or in combination provide similar effect. Conventional issues in financial transactions, historical market data and such were needed to determine the expected price or price range for a capability. In addition, data on fully or almost fully replacing products and services and their associated pricing history were needed for optimal pricing.

Another drawback of the prior art systems is that they do not offer a versatile user interface for purchasing or selling bandwidth.

### SUMMARY OF THE INVENTION

An objective of the present invention is to devise a system of generating presentation of network capacity data that results, in response to a user's request, in displaying said data on a screen, preferably as links between endpoints of the data transmission connection that the user is interested in.

The objective is achieved by a system of collecting from various sources information about communication capabilities and prices, processing this information and storing the processed information on a storage medium. In response to a local or remote user's request, a piece of the processed information is retrieved from the storage medium and transmitted to the user's computer for displaying on the user's display device or hard copy printing. Preferably, processed information is displayed on a map, in charts, and/or in tables. The map is either sent together with the processed information or retrieved from a data storage device of the user's computer.

Additional data not shown immediately on the screen is also sent to the user's computer. This data or some items of it is displayed only in response to the user's selection. In other words, when the user will have more detailed information about a certain link on the map, for example, this information is obtained from the additional data and will be displayed immediately.

Hence, the map with the processed information and the additional information enables the user to do various analyses relating to network capacity being offered and based on the analyses the user can select one offer.

The invented system for distribution and display of data is novel and forms the basis of a key functionality, namely the ability to select communication capabilities by selecting their projection on the map. This view forms the user interface when shown and enables the selection of capability and thus potentially display of further data.

### BRIEF DESCRIPTION OF THE DRAWINGS

The invention is described more closely with reference to the accompanying drawings, in which

FIG. 1 depicts data flow through entities;

FIG. 2 illustrates one embodiment of the invention;

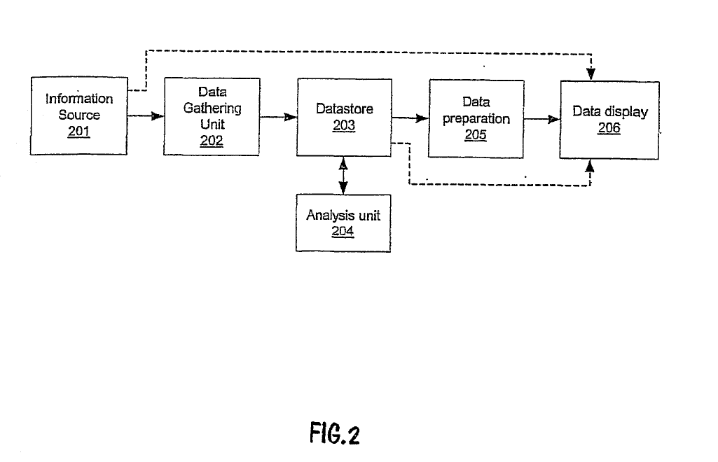

FIG. 3 shows a data gathering flow chart;

FIG. 4 shows a data analysis flow chart;

FIG. 5 illustrated distribution of data to the client machine;

FIG. 6 shows data display states;

FIG. 7 is a flow chart describing selection of data in the display; and

FIG. 8 illustrates a local form embodiment.

### DETAILED DESCRIPTION OF THE INVENTION

The system consists of an information service of a communications capability. Terminals, such as personal computers with associated or additional software can access the service via a communications network. Alternative terminals consist of portable terminals, such as mobile phones, PDAs and the like.

The system includes three basic functions: gathering raw data from various sources, processing raw data for generating refined data applicable to the system, and presentation of data.

The system obtains raw data from a variety of information sources. Sources may be contacted using a communications network but data may be entered manually. Users may also enter data into the system. Data includes the existence of availability or demand, price, availability, liquidity, volatility, capacity, capability type, mediator, parties and financial type of communications capability. Financial type data relates to bid, offer, availability, demand, binding, nonbinding, tariff, industry average, closed deal, derivative instrument and spot trade potential of communications capability. Communications capability relates both to physical transmission resources and transmission methods.

The second function, processing of raw data, may include generation of additional specifiers based on the data alone or in conjunction with context, such as the source of data, the date, time etc. Data may also be simplified. For example, numbers defining the capability may be rounded to certain values, parts of the definition may be ignored or altered or other simplification may result. Data may be combined or split into multiple fields. Raw data may also be processed to fit the constraints of the data model for a particular type of communications capability.

Processing phase generates new data that henceforth is called as refined data. Refined data is stored and users can access it.

Moreover, new data may be generated based in whole or in part on the stored refined data. The refined data can be sorted, various functions, analyses and simulations can be applied. Generation may happen at any later time; immediately after the data storage, at predetermined times, after a sufficient time of no further data entry, at a user instantiated time or in a combination of these. The data that has been generated may be of different forms. These include data usable in a manner similar to original data, as a summary of the characteristics of a single or a set of data, data usable in plotting, charting or mapping the data, data interesting for its characteristic, such as the extremity, average, or an intersection of data.

The third function of the system is data presentation. For presenting data on a display of a remote or local user's terminal it must be retrieved from the storage. This operation will be explained next.

The retrieval generates a single presentation or multiple presentations of data or description of presentation of data. For each presentation at least some of the following steps are performed:

1 Determining initial values of the identifier of data to be retrieved.

2 Getting data from the data store.

3 Creating and storing a local copy of data.

4 If the copy does not contain sufficient data, values of subsequent identifiers are determined and step 2 is repeated.

5 Generating presentation of data. Presentation may be a table, chart, textual presentation and/or map, other visualization or a data description suitable for the generation of one or more other visualizations.

For each presentation an additional separate presentation may exist if one or more local copies are missing or a local copy contains inaccurate or outdated information. In addition, the whole presentation may be replaced by a separate presentation describing the lack of data.

Further, the contents of each of the presentations may be combined to form one or multiple displays of data. These combined displays may contain queries and performing a query generates additional displays of data with selected characteristics. The combined displays of data may contain additional information for executing financial transactions. Transactions may serve for the exact communications capability contract between the transaction parties. Additional information can also be used to enable retrieving of more

Presentations, additional separate presentations and combined displays are transmitted to a user over a communications network either upon request or without explicit request. Preferred way to present data at the user's terminal is to display a map on the screen. Lines drawn in separating colors, textures or widths illustrate capabilities between points on the map. Color, texture or highlight on a geographical area depicts capability of the area. Alternating its color, texture, shape and/or size can highlight a point.

The way of displaying each of the data items may vary based on a characteristic of the item, such as the capacity or price of the item. Further, the data on the map may be linked to a tabular display of data Data may have an associated piece or set of data that is displayed either constantly or upon selection. This associated data may consist of an alternative means of enabling communications capability, such as a cheaper, faster, more available, and more liquid as an asset or more reliable means of transferring data. This additional data may be shown in a variety of ways, e.g. with additional lines, areas or points on a map, a table, a chart or textual description.

### PREFERRED EMBODIMENT OF THE INVENTION

The preferred embodiment of the system is a database backed web site with analysis capabilities. The data in the web site comprises bids and offers of telecommunications capacity retrieved from web-based bandwidth trading marketplaces. The web site enables display of market data on a map with an associated table with the same data in textual and numerical form. The user can do analysis on the data based on the other bids and offers currently available and on the price history of a particular type of capacity between the chosen end points.

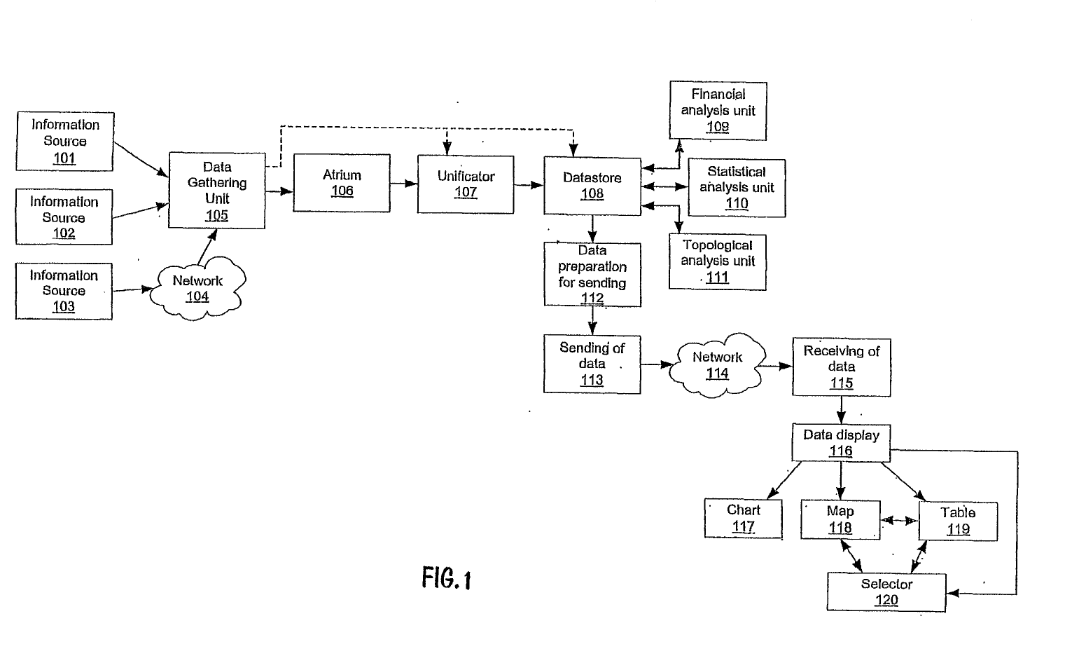

FIG. 1 is a schematic block diagram of the system. The system consists of the following parts:

One or more information sources 101, 102 and 103, network 104, data gathering unit 105, temporary data storage atrium 106, data unification and cleaning unit 107, database 108, financial data analysis unit 109, topological data analysis unit 110, statistical data analysis unit 111, data preparation for sending 112, sending of data 113, network 114, receiving of data 115, data display preparation 116, chart 117, map 118, table 119, and selector 120.

These parts operate on and with Item of telecommunications capability pricing information and list of items.

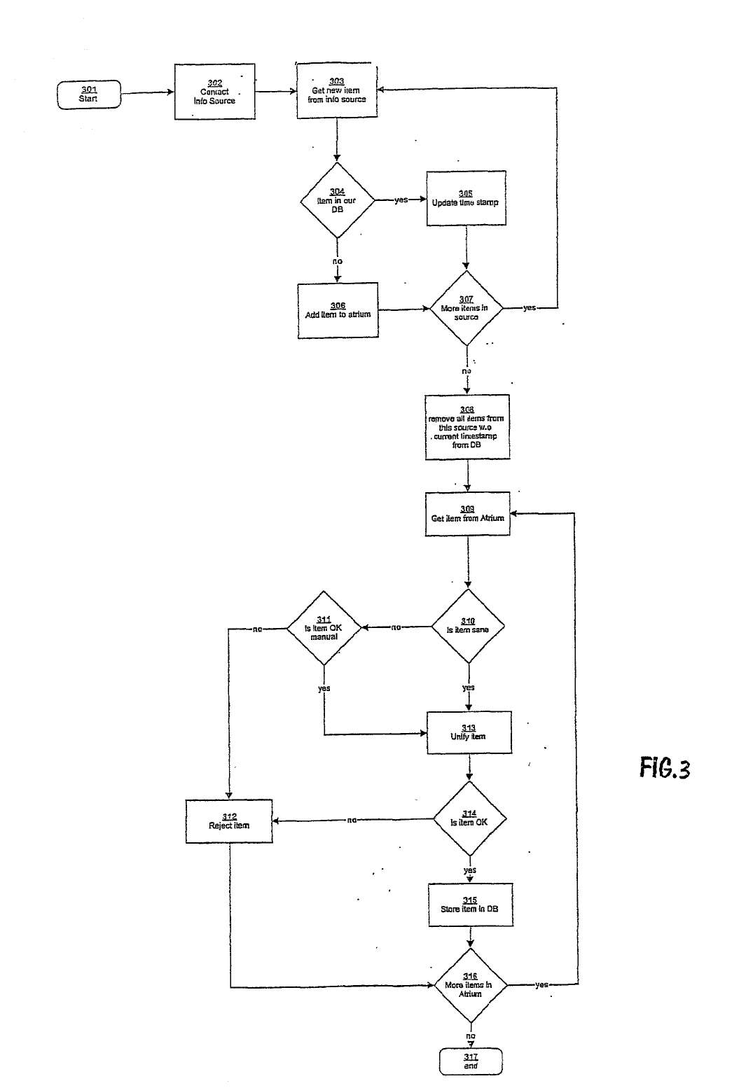

FIG. 3 shows steps when data is gathered from information sources. After gathering has been started, step 301, data gathering unit (105, FIG. 1) contacts an information sources either through the network or directly, step 302. Data gathering unit gets a new item from the list of available items, step 303. Each found item is compared to the full set of items in database 108 of FIG. 1, step 304.

If the offer is found in the database, it's time stamp is updated, step 305. This shows that it is still current. If the offer is new, it is entered in the atrium 106 together with additional information related to the third party data source, step 306. If there are unprocessed items in the list of available items step 303 is retaken, step 307.

Items relating to telecommunications capability pricing information are in the database without a current status, but for this third party data source are retired, step 308. This means, that the item will not be considered current or available. Then item is fetched from the atrium 106, step 309. The sanity of item is checked, step 310. This contains the evaluation of the values and comparison to known good value sets in the database.

If necessary the item is checked manually by the operator), who may accept or reject the entry, step 311. If the item did not pass the automatic and manual sanity checks and/or the unification failed, the item is retired, step 312. Each item in the atrium is transformed into uniform structure, step 313. This includes adding fields that are known to be constant for a particular data source, but vary in input from others, unifying the topological and geographical information, i.e locations, area codes, and such.

In step 314 success of unification is checked. If checking is successful, the items in the atrium are stored in the database, step 315. If there are more items in atrium, another item is fetched, step 316. If there are no more items, the process ends, step 317.

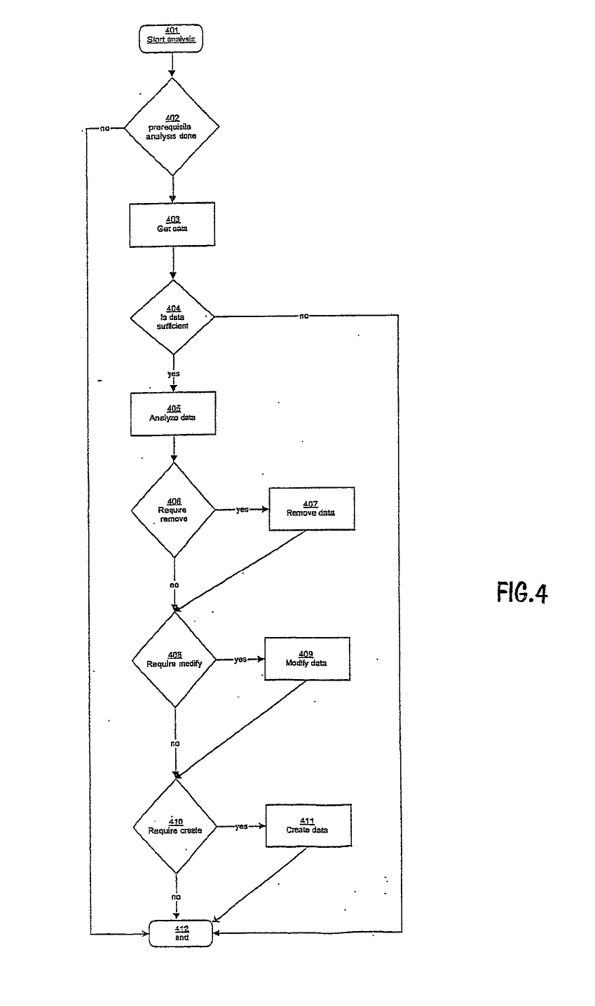

FIG. 4 shows method steps that are taken for each analysis so that the ordering of the analysis fulfills the prerequisite demands in single or plural rounds of application. After starting the analysis, step 401, it is checked whether the prerequisite analysis has been done, step 402. If not, the process ends. If yes, data is fetched, step 403. Then, it is checked whether data is sufficient for the analysis, step 404. If not, the process ends. If yes, data is analyzed, step 405. Next, it is checked whether data is to be removed, step 406. If so, data remove data in database 108. Then it is checked whether data is to be modified, step 408. If yes, data is modified in database 108, step 409. Next check concerns whether data is to be created, step 410. If yes, data is created in database 108, step 411. Thereafter the process ends, step 412.

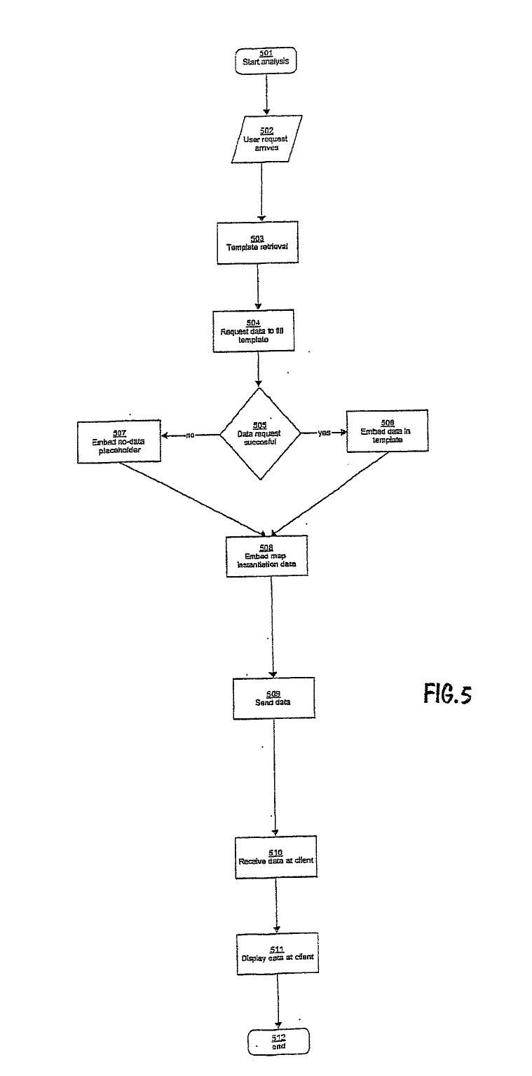

FIG. 5 depicts steps taken when a user has contacted the system and data is distributed to the client machine. In step 502 user's request arrives to the server. First, a template is retrieved, step 503. Then, request of data required filling the template from the database is done, step 504. Next, it is checked whether data has been retrieved, step 505. If yes, data is embedding the template, step 506. If no, placeholder “no data” is embedded, step 507. Then it is performed embedding of the data required to instantiate the map component, step 508, and data is sent to the user, step 509. User's machine receives data, step 511, and displays it on the screen, step 511.

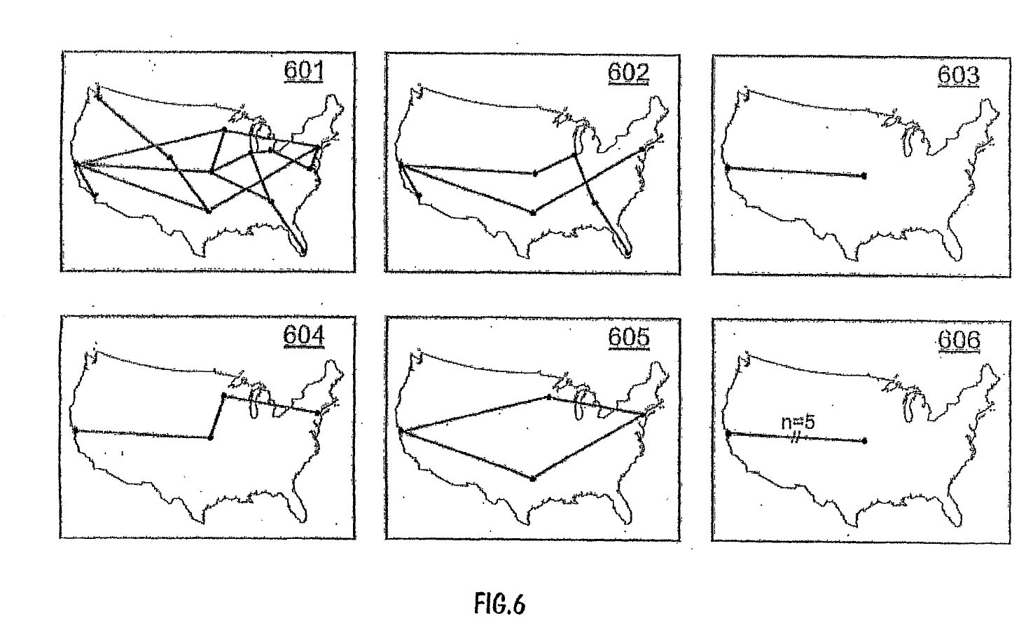

FIG. 6 shows what the user sees on the display. The view is the user interface data display. A single communications capability or multiple communications capabilities, i.e. links, can be displayed simultaneously on the screen. The means of displaying multiple items is identical to that of displaying a single one described here.

The link is shown on a map, which may be geographically accurate. It has two endpoints and selecting it using a natural mechanism of the environment causes displaying of further data related to the link.

FIG. 601 shows a display of the minimally constrained set of links on a map. This display contains links and nodes that belong to the visible area together with links that have at least one of their endpoints in this area. For semantic and visual reasons the number of visible links can be limited by the means of importance weighting.

FIG. 602 shows a display of explicitly constrained set of links on a map. This display contains the elements of 601, if they fit the constraints implicitly or explicitly set by the system or user.

FIG. 603 shows a display of data with direct connectivity constrained by its endpoints, the so-called single-hop case. This display contains data for which the endpoints have been set. In addition other constraints can further limit the data.

FIG. 604 shows a display of data in chains of connectivity between constrained endpoints. The display of data, such as a set of links constituting the cheapest route, between constrained end points.

FIG. 605 shows a display of multiple chains, or single-hops simultaneously between constrained end points. These form sets of alternative routes between the end points.

FIG. 606 shows a display of multiple single-hops of data with their simultaneous and totally overlapping nature made explicitly visible.

The map is not a mere displaying device, unless output on a hardcopy medium or the like without selective capability. In addition to the displaying properties, the map can be used to show interest in a communications capability. The interest may realize itself in multiple forms, for example, the moving of a pointing device, the selection with a pointing device or a combination thereof. The selection may also be a result of previous computation and thus either a byproduct, or a result of the aforementioned.

The result of the interest may present itself as additional information on the selected capability or capabilities, the comparison of selected capabilities, alter the presentation of the data or result in a further action internally or externally to the system.

When a map is combined with another or similar display medium, a selection in one may cause a selection in the other. The data may also be selected alternatively or solely from an independent selection implement. The selection of data may cause the showing of another set of data, or the change in some of the adjunct data.

The user visible system interaction consists of a sequence of selections of data and the perception of system change in response to these selections. The system selection model and the consequences of the model are thus an important facet of operations.

The system can due to its design and implementation be reasonably started at any of the states. A return from any of the states to the initial state is also possible.

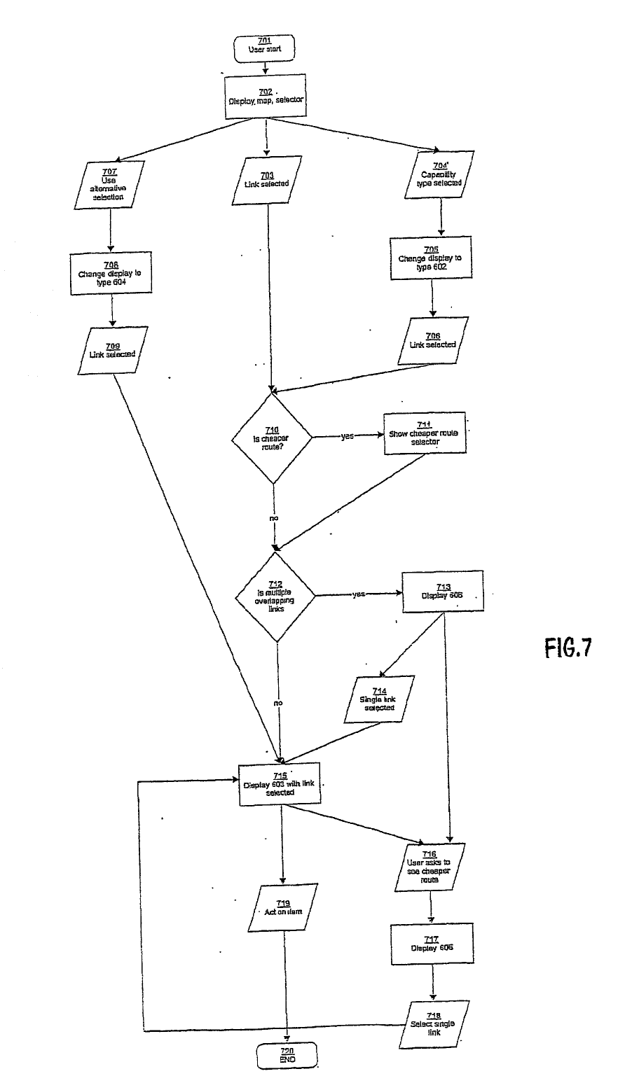

Turning now to FIG. 7, some selections steps performed by a user is shown. The user enters the web site, step 701. On the screen it is shown display 601 of the main screen with a map and a selector displaying the available topologically or geographically defined communications capabilities, i.e. links between two points.

Selecting a link on the map, in the selector or in a table forces the focus of the other two selection mechanisms to the same link, steps 703, 706, 709, 714, 718. In addition to the link, one can also select the type of communications capability one is interested in using the selector or the table, step 704. In response, display type is changed, step 705. Using one of the alternative selection mechanisms one can select the view of the cheapest route between two points, step 707. In response, the display changes its state to state 604 of FIG. 6, step 708. Then the user inquires whether there is a cheaper route, step 710. If so, the cheaper route selector is shown in addition to other components, step 711. Next the user inquires using selection whether there are multiple overlapping links, step 712. In response to this the map is displayed in state 606 of FIG. 6, step 713. Then is shown the display (603) with a single link selected, step 715. Now the user can inquire whether there is a cheaper route, step 716. If such a route exists, it is shown on the display, step 717. The view can be similar to FIG. 605. In step 719 the user may select in the display (603) an item that enables either the acting on the item or the viewing of the information needed to act on the item. Typical actions are bids, offers, buying and selling derivative instruments and making a counteroffer/bid to the one shown at possibly better terms.

Finally, at the end the system may return to step 701 or leave the display.

### ANOTHER EMBODIMENT OF THE INVENTION

The preferred embodiment of the invention can also be implemented using software local to a single machine or network of computers. In this case the user can do analysis on the data based on the other bids and offers currently available and on the price history of a particular type of capacity between the chosen end points.

Referring to FIG: 2, the system according to this embodiment consists of the following parts: One or more information sources 201, data gathering unit, data store 203, data analysis unit 204, data preparation unit 205, and data display 206.

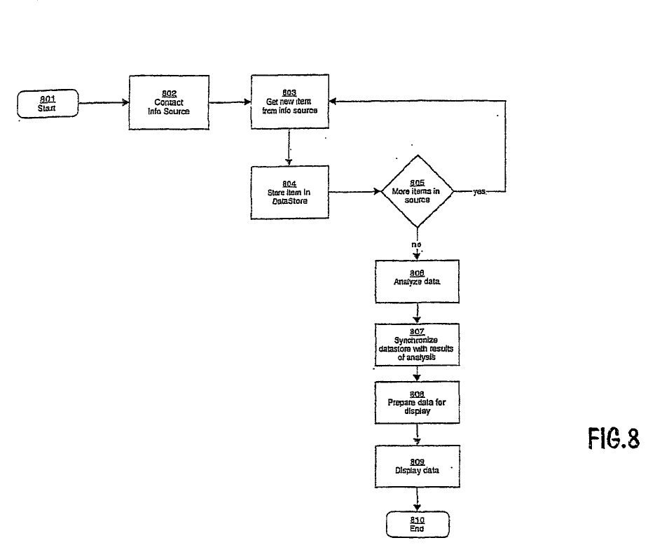

Steps taken by this system is shown in FIG. 8. After starting, step 801, data gathering unit 202 contacts an information source 201, step 802. In response, data gathering unit gets a new item from the source, step 803. Then the item is entered in the data store, step 804. If there are more items in the source, step 803 is retaken. Next data from data store is analyzed, step 806. In step 807 the results of the analysis are synchronized with the data store including the removal, addition and modification of data already in the store. Then data is prepared for display, step 808, and data is displayed, step 809.

1. A system of presenting communication capabilities, characterized in that the system comprises:
a data-gathering unit (105) for collecting raw information about available communication capabilities and prices from various information sources,
processing means (107) for generating refined data from the raw information,
data storage (108) for storing refined data
means (109, 110, 111) for analyzing refined data and storing analyzed data in the data storage,
data preparation means (112) which in response to a remote or local user's request for presentation:
retrieve from a storage at least one template suitable for the presentation,
fetch from the data storage (108) data needed for embedding in the template,
sending means for sending the presentation to the user.

2. The system as in claim 1, characterized in that the data-gathering unit communicates with the information sources through a network.

3. The system as in claim 1, characterized in that it further comprises temporary data storage for storing raw information provisionally.

4. The system as in claim 1, characterized in that the data-gathering unit (105) compares items of raw information to the corresponding old items stored in the data storage (108) and when a change is found an old item is replaced with the new item with a time stamp.

5. The system as in claim 3, characterized in that processing means (107) fetch raw data items from the temporary data storage, compare values of said items to known values and accept a raw data item if the difference is acceptable.

6. The system as in claim 1, characterized in that processing means (107) transforms the raw data items into uniform structure.

7. The system as in claim 1, characterized in that means (109, 110, 111) for analyzing refined data apply statistical analysis to refined data.

8. The system as in claim 1, characterized in that means (109, 110, 111) for analyzing refined data apply financial analysis to refined data.

9. The system as in claim 1, characterized in that means (109, 110, 111) for analyzing refined data apply topological analysis to refined data.

10. The system as in claim 1, characterized in that the form of the presentation is a map comprising a plurality of links between the start point and end point chosen by the user.

11. The system as in claim 10, characterized in that to each of the links is attached information relating to the link, wherein in response to the user's action information is shown.

12. The system as in claim 11, characterized in that information relating to a link comprises at least capacity and price of the link.

13. The system as in claim 10, characterized in that the presentation includes queries and in response to a query a new presentation is sent to the user.

14. The system as in claim 3, characterized in that processing means (107) transforms the raw data items into uniform structure.
